(19) United States
(12) Patent Application Publication
(10) Pub. No.: US 2015/0070331 A1
(43) Pub. Date: Mar. 12, 2015

(54) DIGITAL PEN

(71) Applicant: FUNAI ELECTRIC CO., LTD., Osaka (JP)

(72) Inventor: Kentaro KAJIHARA, Osaka (JP)

(21) Appl. No.: 14/474,347

(22) Filed: Sep. 2, 2014

(30) Foreign Application Priority Data
Sep. 6, 2013 (JP) 2013-185675

(51) Int. Cl. G06F 3/03; G06T 7/40; G06F 3/0354

(52) U.S. Cl. CPC G06F 3/0304; G06F 3/03545; G06T 7/408; G06T 2207/10004; G06T 2207/10024; G06T 2207/20112
USPC 345/179

(57) ABSTRACT

A digital pen includes: an image obtainment unit; an area division unit; an average calculation unit for calculating a first average which is an average luminance in a first area and a second average which is an average luminance in a second area; a storage unit for storing the first average; a control unit for repeating a first average determination process in which, when a current first average exceeds a current second average and the first average stored in the storage unit, the first average stored in the storage unit is updated with the current first average, a predetermined number of times while changing a first reference point and a second reference point; and a drawing area determination unit for determining, as a drawing area, the first area corresponding to the first average stored in the storage unit after the first average determination process is repeated by the control unit.

### CROSS REFERENCE TO RELATED APPLICATION

The present application is based on and claims priority of Japanese Patent Application No. 2013-185675 filed on Sep. 6, 2013. The entire disclosure of the above-identified application, including the specification, drawings and claims is incorporated herein by reference in its entirety.

### FIELD

One or more exemplary embodiments relate to a digital pen for making a drawing in a planar drawing area.

### BACKGROUND

Recently, instead of conventional pens or pencils, a digital pen capable of storing, on a personal computer, motion trajectory information representing characters or figures drawn by moving the pen tip on a paper is becoming popular.

Such a digital pen requires positional information of the pen tip to obtain the motion trajectory information. In order to obtain the positional information of the pen tip, absolute positional information representing absolute positional information of the pen tip on the paper is needed. In order to obtain the absolute positional information, the pen tip must be on the paper.

Patent Literature (PTL) 1 discloses that a white board provided with a specific pattern for position detection thereon can be used to determine where information is written and what is written.

### CITATION LIST

### Patent Literature

[PTL 1] Japanese Patent No. 4920153

### SUMMARY

### Technical Problem

In the PTL 1, however, a specific pattern for position detection is required to identify the position of a pen tip, which leads to a lack of versatility.

There is a technique of: when a pen tip is in contact with a paper disposed on a desk, capturing an image of the paper and the desk surface with a camera from above; dividing the captured image into a light portion in the vicinity of the pen tip (a white and near-white portion) and a dark portion away from the pen tip (a color away from white); when there is a predetermined difference between the light portion and the dark portion, deciding that the pen tip exists on the paper.

Unfortunately, when a part of the light portion in the image is, for example, a “high-luminance desk surface portion in the vicinity of the pen tip”, the part of the light portion is also regarded as a part of the image of the paper. In other words, although the part of the light portion does not belong to the image of the paper, the “high-luminance desk surface portion in the vicinity of the pen tip” is incorrectly determined as the paper because there is a difference between the average luminance of the high-luminance desk surface portion approximately equal to the average luminance of the paper and the average luminance of the dark portion.

Moreover, when the part of the light portion in the image is the “high-luminance desk surface portion in the vicinity of the pen tip”, the luminance value of the “high-luminance desk surface portion in the vicinity of the pen tip” is used to calculate the average luminance of the light portion. As a result, the calculated average is different from the average obtained when the light portion in the image includes only the paper. When there are multiple “high-luminance desk surface portions in the vicinity of the pen tip”, the difference between the averages increases as more unnecessary luminance values are used to calculate the average.

One non-limiting and exemplary embodiment has been conceived to solve the aforementioned problem, and provides a digital pen capable of accurately determining a drawing area even when a non-drawing area having a relatively high average luminance exists in the vicinity of the digital pen.

### Solution to Problem

In general aspect, the techniques disclosed here feature a digital pen for making a drawing in a drawing area having a planar configuration, the digital pen including: an image obtainment unit configured to obtain an image of an area including the digital pen and the drawing area; an area division unit configured to divide the image obtained by the image obtainment unit into: a first area that is displayed in a color of a first reference point and a color close to the color of the first reference point; and a second area that is displayed in a color of a second reference point and a color close to the color of the second reference point, the second reference point being farther away from the digital pen than the first reference point; an average calculation unit configured to calculate a first average and a second average, the first average being an average luminance in the first area, the second average being an average luminance in the second area; a storage unit for storing the first average; a control unit configured to repeat a first average determination process a predetermined number of times while changing the first reference point and the second reference point, the first average determination process being a process in which: whether or not a current first average exceeds a current second average is decided; and when the current first average exceeds the current second average and the first average stored in the storage unit, the first average stored in the storage unit is updated with the current first average; and a drawing area determination unit configured to determine, as the drawing area, the first area corresponding to the first average stored in the storage unit after the first average determination process is repeated the predetermined number of times by the control unit.

With this, the first average determination process is performed a predetermined number of times, and then the first area corresponding to the first average stored in the storage unit is determined as the drawing area.

In this way, even when an area where the luminance is relatively high but lower than that of the drawing area, such as a non-drawing area, is included in the first area, the average luminance of the first area is lower than that of the first area including only the drawing area because the luminance of the non-drawing area is lower than that of a paper.

As a result, when the first area includes the area where the luminance is relatively high but lower than that of the drawing area, it is possible to prevent the first area from being incorrectly determined to be a paper. Thus, the accuracy of identifying the drawing area is improved.

For example, the first average stored in the storage may be greater than or equal to a predetermined initial reference value.

Furthermore, for example, the first reference point may be an inner end of a line segment, and the second reference point may be an outer end of the line segment, the line segment being one of a plurality of line segments radially arranged around a predetermined point in the image.

With this, the first reference point is an inner end of each of the line segments radially arranged around a predetermined point in the image, and the second reference point is an outer end of each line segment.

Accordingly, compared with a random setting of the first reference point and the second reference point in the image, the even arrangement of the first reference point and the second reference point can be achieved in a wide range.

Furthermore, for example, the first reference point and the second reference point may be each a predetermined point on the line segment.

With this, the first reference point and the second reference point are also placed on each of the radially-arranged line segments, and thus more first reference points and more second reference points can be reserved as the number of line segments increase.

Accordingly, the number of first averages to be used for update when the first average exceeds the second average increases as more reference points are reserved. As a result, the accuracy of determining the first area as the drawing area is further improved.

Furthermore, for example, the drawing area determination unit may determine, as the drawing area, a rectangle including all points on a boundary between the first area corresponding to the first average stored in the storage unit and the second area after the first average determination process is repeated the predetermined number of times.

With this, multiple points are drawn on the boundary between the first area determined as the drawing area and the second area, and a rectangle including all the points is obtained as an image representing the drawing area. Accordingly, it is possible to obtain information representing the drawing area through easy software processing.

Furthermore, for example, the digital pen may further include an estimation unit for estimating a position of the digital pen based on the drawing area determined by the drawing area determination unit, in which the storage unit further stores positional information indicating the position estimated by the estimation unit.

With this, the digital pen estimates the position based on the drawing area, and thus it is possible to estimate the position of the digital pen without requiring the specific pattern for position detection.

Furthermore, for example, the digital pen may further include a positional information output unit for outputting the positional information to a communication device used in combination with the digital pen.

With this, the foregoing digital pen can provide the positional information to the communication device, and thus the communication device can obtain the motion trajectory of the digital pen from the provided positional information. Accordingly, characters or figures drawn in the drawing area with the digital pen can be stored on the communication device in a paperless manner.

It is to be noted that one or more exemplary embodiments disclosed herein may be implemented as not only a digital pen but also: a method including, as steps, processing units included in the digital pen; a program for causing a computer to execute the steps; a computer readable recording medium, such as a CD-ROM, storing the program; and information, data, or signal indicating the program. The program, information, data, and signal may be distributed via a communication network such as an Internet.

### Advantageous Effects

According to one or more exemplary embodiments, it is possible to accurately determine a drawing area even when a non-drawing area having a relatively high average luminance exists in the vicinity of a digital pen.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 illustrates a side view showing an exemplary outline of a digital pen according to one exemplary embodiment 1.

FIG. 2 illustrates a block diagram showing an exemplary functional configuration of the digital pen.

FIG. 3 illustrates an example of an image captured by a camera module.

FIG. 4 illustrates an example of a corrected image obtained by correcting the captured image in an image correction unit.

FIG. 5 illustrates a flowchart showing an exemplary basic operation of the digital pen according to the embodiment 1.

FIG. 6 illustrates an example of a divided image divided by an area division unit.

FIG. 7 illustrates a black-and-white image obtained by binarizing the divided image.

FIG. 8 illustrates a diagram for describing an operation of a digital pen according to one exemplary embodiment 2.

FIG. 9 also illustrates a diagram for describing the operation of the digital pen according to the embodiment 2.

FIG. 10 illustrates a diagram for describing an operation of a digital pen according to one exemplary embodiment 3.

FIG. 11 illustrates a diagram for describing an operation of a digital pen according to one exemplary embodiment 4.

### DESCRIPTION OF EMBODIMENTS

Hereinafter, certain exemplary embodiments are described in detail with reference to the accompanying Drawings. Each of the exemplary embodiments described below shows a general or specific example. The structural elements, the arrangement and connection of the structural elements etc. shown in the following exemplary embodiments are mere examples, and therefore do not limit the scope of the appended Claims and their equivalents. Therefore, among the structural elements in the following exemplary embodiments, structural elements not recited in any one of the independent claims are described as arbitrary structural elements.

### Embodiment 1

### <Structure of Digital Pen>

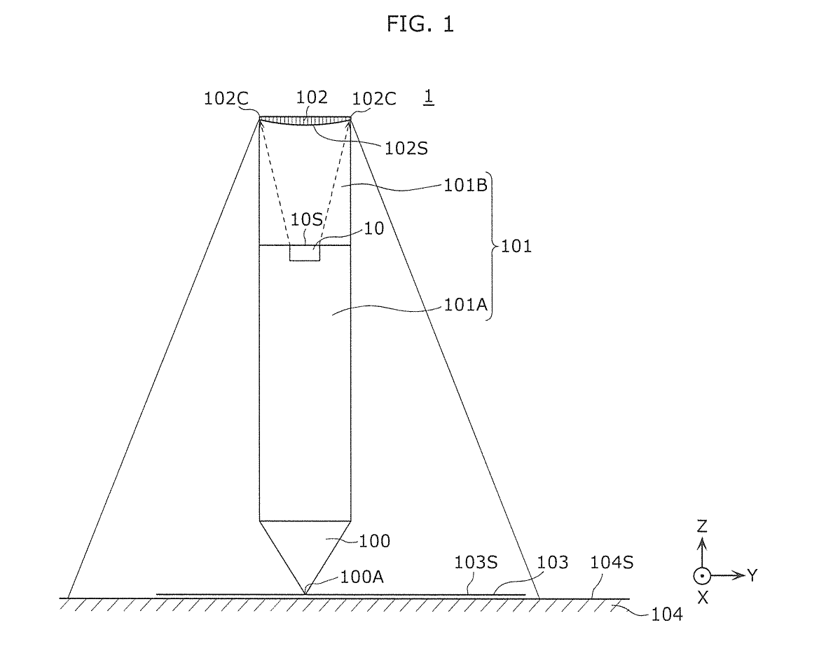

FIG. 1 illustrates a side view showing an exemplary outline of a digital pen according to one exemplary embodiment 1. It is to be noted that, besides a digital pen 1, FIG. 1 also shows a paper 103 disposed on the desk surface 104S of a desk 104 as a planar drawing area in which a drawing is made with the digital pen 1. In FIG. 1, the x-axis is along a width direction of the paper 103, the y-axis is along a length direction of the paper 103, and the z-axis is along a height direction of the digital pen 1.

The digital pen 1 includes a pen tip assembly 100 and a main body 101. The pen tip assembly 100 includes a pen tip 100A in contact with the paper surface 1035 which is the surface of the paper 103. Ink supplied from an ink cartridge in the main body 101 may exit from the pen tip 100A. Alternatively, the structure of the pen tip assembly 100 may be the same as that of a tip portion of a pencil.

The main body 101 includes a lower main body portion 101A and an upper main body portion 101B which are separated by a camera module 10. The lower main body portion 101A is used when a user grips it with his/her hand to draw characters or figures on the paper surface 103S. Accordingly, the lower main body portion 101A may include the above-mentioned ink cartridge.

An inner head portion of the upper main body portion 101B is provided with a hemisphere mirror 102 so that the mirror surface 102S faces to the paper 103. The mirror surface 102S of the hemisphere mirror 102 reflects the digital pen 1, the paper surface 103S of the paper 103 disposed on the desk surface 1045 of the desk 104, and the desk surface 104S.

The camera module 10 is provided with an image-capturing surface 105 facing to the hemisphere mirror 102. The camera module 10 captures a mirror image on the mirror surface 102S of the hemisphere mirror 102 to obtain an image IM1 of the mirror image.

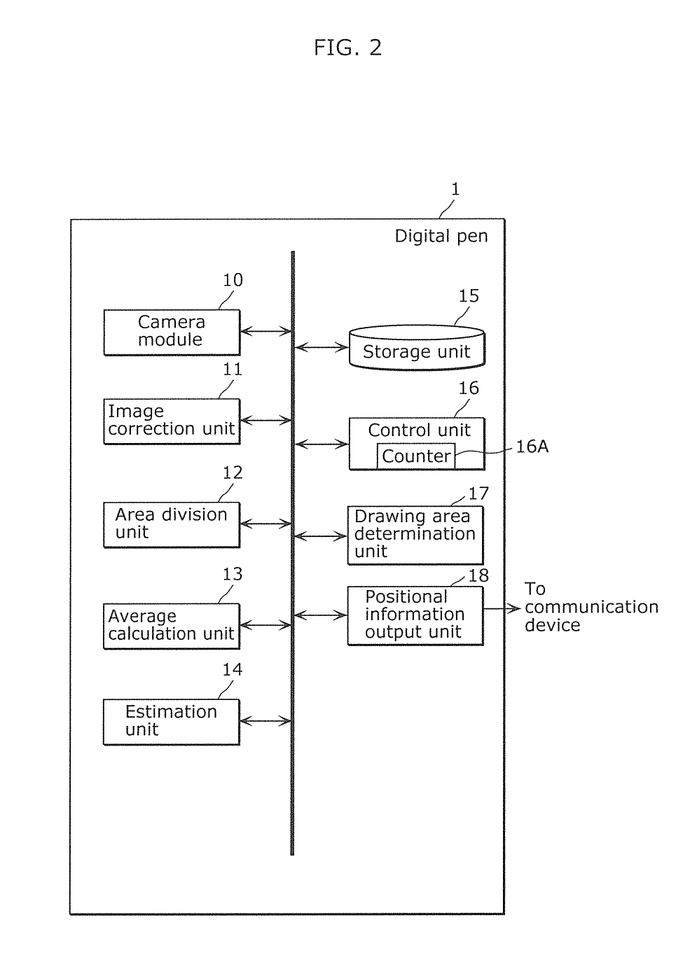

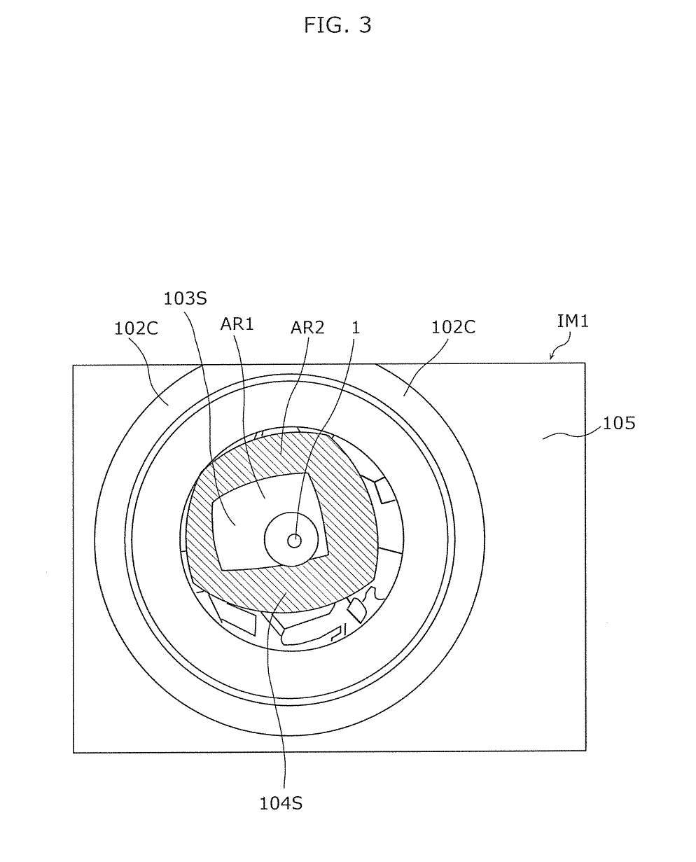

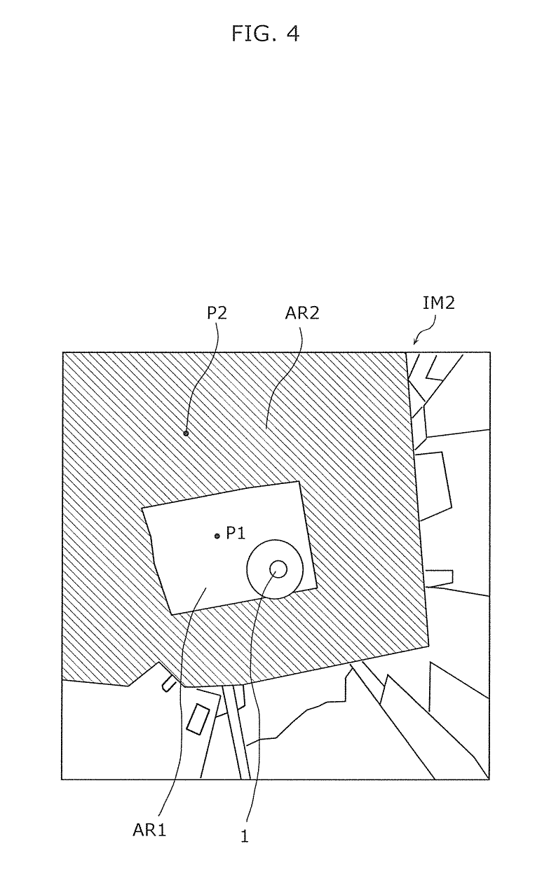

FIG. 2 illustrates a block diagram showing an exemplary functional configuration of the digital pen 1. FIG. 3 illustrates an example of an image IM1 captured by a camera module 10. FIG. 4 illustrates an example of a corrected image IM2 obtained by correcting the captured image IM1 in an image correction unit 11.

It is to be noted that, in FIG. 3 and FIG. 4, the first area AR1 represented as a white area is an area that is displayed in a color of a first reference point (for example, white) and a color close to the color of the first reference point (for example, a color within a predetermined range from white), while the second area AR2 represented as a hatched area is an area that is displayed in a color of a second reference point which is farther away from the digital pen 1 than the first reference point (for example, green) and a color close to the color of the second reference point (for example, a color within a predetermined range from green).

The digital pen 1 include the camera module 10, the image correction unit 11, an area division unit 12, a average calculation unit 13, an estimation unit 14, a storage unit 15, a control unit 16, a drawing area determination unit 17, and a positional information output unit 18.

As described above, the camera module 10 captures the image IM1 of the mirror image on the mirror surface 102S of the hemisphere mirror 102. In other words, the camera module 10 obtains the image IM1 of an area including the digital pen 1 and the paper 103 (drawing area). The image IM1 obtained in this manner is shown in FIG. 3.

The image correction unit 11 performs predetermined correction on the image IM1 captured by the camera module 10. For example, the image IM1 captured by the camera module 10 is distorted as shown in FIG. 3, and thus the image correction unit 11 corrects the distortion to facilitate the color-based division of the image. Specifically, as shown in FIG. 3, the image IM1 includes portions unnecessary to decide whether or not the digital pen 1 faces to the paper surface 103S (for example, the rim 102C of the hemisphere mirror 102, and a ceiling 105), and thus the image correction unit 11 removes the unnecessary portions and transform the resulting image into a substantially rectangular image. In this way, the corrected image IM2 as shown in FIG. 4 is generated.

The area division unit 12 divides the corrected image IM2 generated by making the correction in the image correction unit 11 into: the first area AR1 of the color of the first reference point and the color close to the color of the first reference point; and the second are AR2 of the color of the second reference point and the color close to the color of the second reference point. In other words, the corrected image IM2 is divided into: the first area that is displayed in the color of the first reference point and the color close to the color of the first reference point; and the second area that is displayed in the color of the second reference point and the color close to the color of the second reference point. For example, the area division unit 12 makes the division using the well-known WATERSHED method.

With the WATERSHED method, the luminance of each of the pixels in the corrected image IM2 is regarded as altitude information or depth information of a map. The same luminances are connected with a contour line or a depth contour line, and a dividing ridge is detected when water is filled from the first seed point serving as the first reference point P1 and the second seed point serving as the second reference point P2. Thus, the area division unit 12 divides the corrected image IM2 into the first area AR1 and the second area AR2.

The average calculation unit 13 calculates respective average luminances in the first area AR1 and the second area AR2 obtained by dividing the corrected image IM2 in the area division unit 12. In other words, the average calculation unit 13 calculates a first average being the average luminance in the first area AR1 and a second average being the average luminance in the second area AR2.

The estimation unit 14 estimates the position of the digital pen 1 based on an area determined as the paper 103 (drawing area) by the drawing area determination unit 17 to be described below. Specifically, the estimation unit 14 takes advantage of the digital pen 1 located at the center in the corrected image IM2 to obtain the center coordinate of the corrected image IM2 with respect to the area determined as the paper 103. Thus, the position of the digital pen 1 relative to the paper 103 is estimated. Furthermore, the estimation unit 14 may include a gyro sensor. The position of the digital pen 1 may be estimated using the angular velocity about the x-axis and the angular velocity about the y-axis (see FIG. 1) detected by the gyro sensor.

The storage unit 15 stores a control program for activating the digital pen 1. Furthermore, the storage unit 15 stores an initial reference value to be used in a first average determination process to be described below. The storage unit 15 also stores the first average (an average luminance in the first area AR1) obtained by the first average determination process. In addition, the storage unit 15 stores positional information indicating the position of the digital pen 1 estimated by the estimation unit 14.

The control unit 16 totally controls the digital pen 1. The control unit 16 includes CPU (Central Processing Unit), RAM (Random Access Memory), ROM (Read Only Memory), and others, and the CPU executes a predetermined control program to achieve the functionality. The control unit 16 repeats a first average determination process a predetermined number of times while changing the first reference point P1 and the second reference point P2, the first average determination process being a process in which: whether or not a current first average exceeds a current second average is decided; and when the current first average exceeds the current second average and the first average stored in the storage unit 15, the first average stored in the storage unit 15 is updated with the current first average. The control unit 16 has a counter 16A used in the first average determination process.

The drawing area determination unit 17 determines, as the paper 103 (drawing area), the first area corresponding to the first average stored in the storage unit 15 after the first average determination process is repeated the predetermined number of times by the control unit 16.

When the digital pen 1 connected to a communication device such as a personal computer receives a specific instruction, the positional information output unit 18 outputs the positional information stored in the storage unit 15 to the communication device.

### <Operation of Digital Pen>

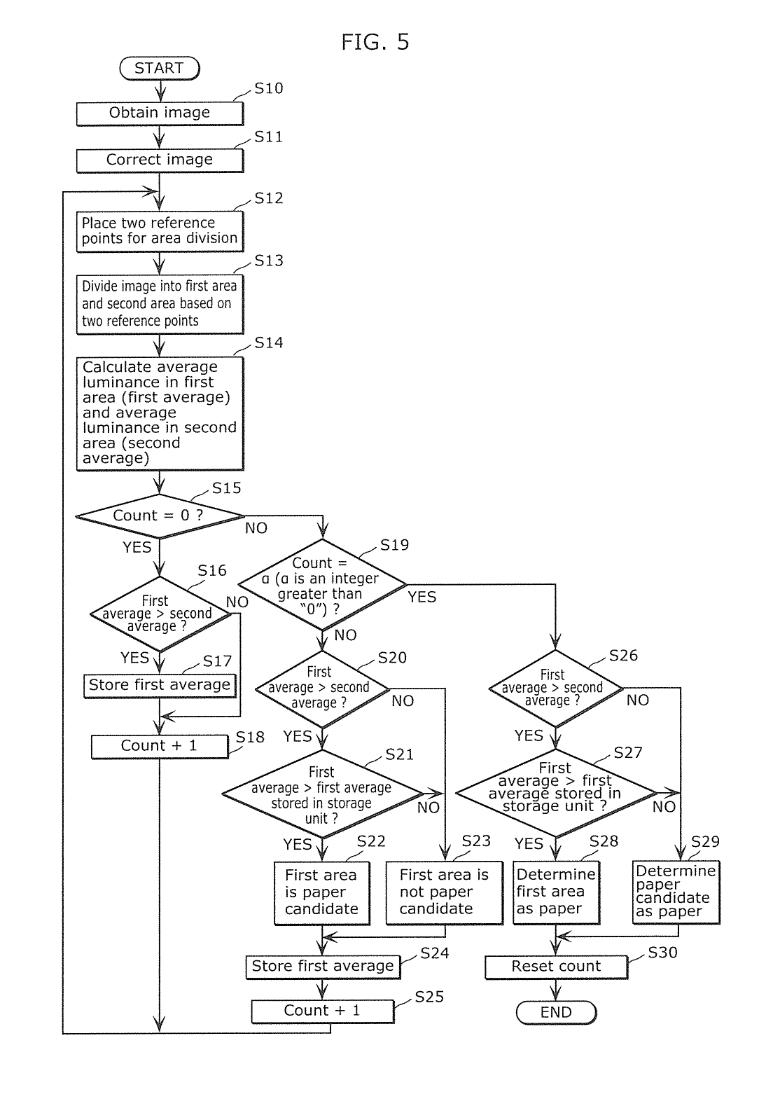

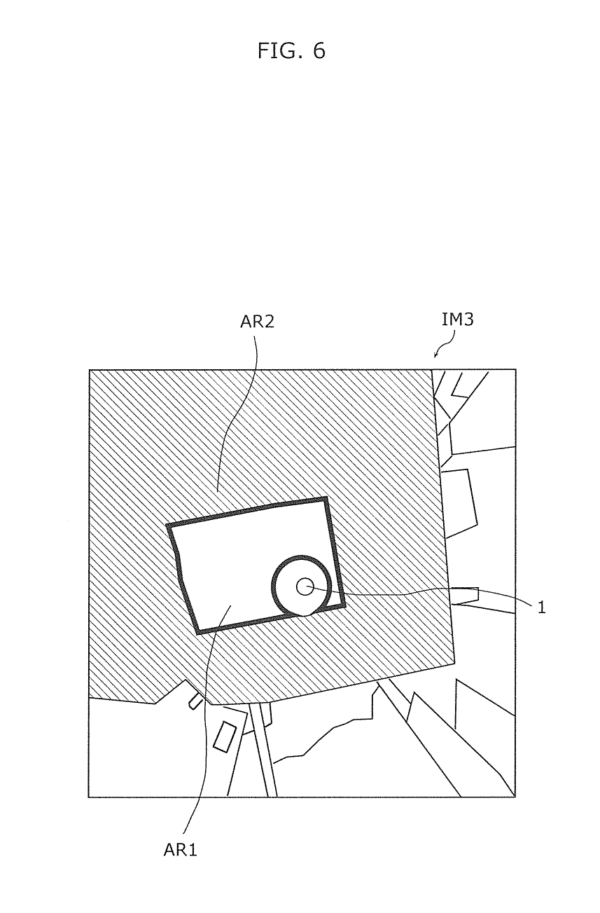

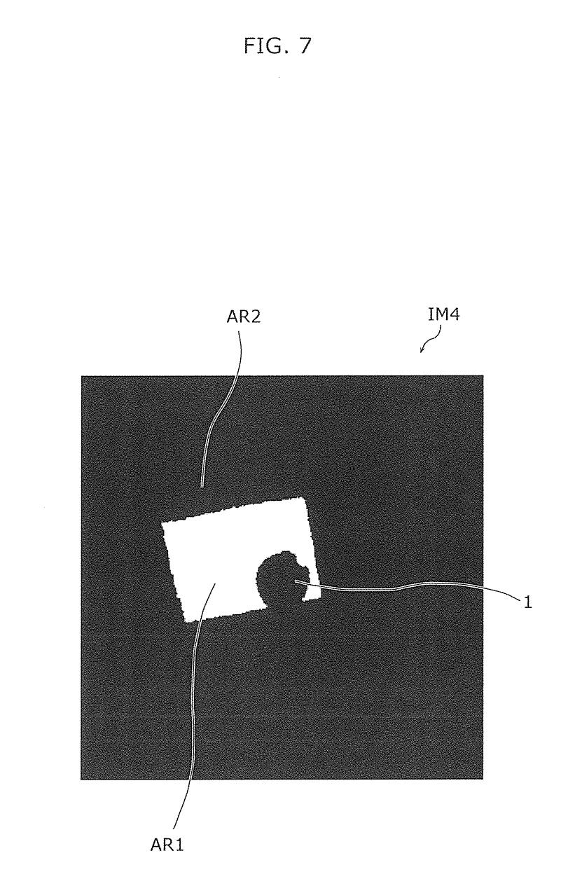

FIG. 5 illustrates a flowchart showing an exemplary basic operation of the digital pen 1 according to the embodiment 1. FIG. 6 illustrates an example of a divided image IM3 divided by the area division unit 12. FIG. 7 illustrates a black-and-white image IM4 obtained by binarizing the divided image IM3 such that the light portion is represented by white and the dark portion is represented by black to clarify the shading of the divided image IM3 shown in FIG. 6.

Like FIG. 3 and FIG. 4, in FIG. 6, the first area AR1 represented as a white area is an area that is displayed in the color of the first reference point (for example, white) and a color close to the color of the first reference point (for example, a color within a predetermined range from white), while the second area AR2 represented as a hatched area is an area that is displayed in the color of the second reference point which is farther away from the digital pen 1 than the first reference point (for example, green) and a color close to the color of the second reference point (for example, a color within a predetermined range from green).

The control unit 16 obtains the image IM1 shown in FIG. 3 with the camera module 10 (Step S10). The image IM1 includes an image of the digital pen 1, an image of the first area AR1 that is assumed as the paper surface 103S, and an image of the second area AR2 that is assumed as the desk surface 104S. As described above, the image IM1 also includes an image of the rim 102C of the hemisphere mirror 102 and an image of the ceiling 105.

Next, the control unit 16 causes the image correction unit 11 to make the foregoing correction to convert the image IM1 into an image appropriate to the area division (Step S11). In other words, the image correction unit 11 corrects the distortion of the image IM1, and removes the image of the rim 102C of the hemisphere mirror 102 and the image of the ceiling 105. In this way, the corrected image IM2 shown in FIG. 4 can be obtained.

Next, as shown in FIG. 4, the control unit 16 places, in the corrected image IM2, the first reference point P1 in the vicinity of the digital pen 1 and the second reference point P2 in a position farther away from the digital pen 1 than the first reference point P1 (Step S12).

Next, the control unit 16 causes the area division unit 12 to divide the corrected image IM2 into: the first area AR1 whose color is the color of the first reference point P1 and a color within a predetermined range from the color of the first reference point P1; and the second area AR2 whose color is the color of the second reference point P2 and a color within a predetermined range from the color of the second reference point P2 (Step S13).

In this way, as shown in FIG. 6, the corrected image IM2 is divided into: the first area AR1 whose color is the color of the first reference point P1 (in this case, white) and a color within a predetermined range from the color of the first reference point P1; and the second area AR2 whose color is the color of the second reference point P2 (in this case, green) and a color within a predetermined range from the color of the second reference point P2.

Next, the control unit 16 causes the average calculation unit 13 to calculate the respective average luminances in the first area AR1 and the second area AR2 (Step S14). In other words, the first average being the average luminance in the first area AR1 and the second average being the average luminance in the second area AR2 are calculated by the average calculation unit 13.

Next, when a count of the counter 16A is “0” (YES in Step S15), the control unit 16 decides whether or not the average luminance in the first area AR1 (referred to as the first average) exceeds the average luminance in the second area AR2 (referred to as the second average) (Step S16).

If the first average exceeds the second average (YES in Step S16), then the control unit 16 stores the first average in the storage unit 15 (Step S17). The control unit 16 also stores the first area AR1 corresponding to the stored first average, in the storage unit 15 as a paper candidate. Next, the control unit 16 increments the count by 1 (Step S18).

In contrast, if the first average is lower than or equal to the second average (NO in Step S16), then the control unit 16 increments the count by 1 without storing the first average in the storage unit 15 (Step S18).

It is to be noted that the processing when the count of the counter 16A is “0” as described above (Step S16 to Step S18) is processing for obtaining the foregoing “initial reference value” (hereinafter, referred to as a “initial reference value determination process”). Accordingly, instead of obtaining the initial reference value in the initial reference value determination process, it is possible to pre-store the initial reference value in the storage unit 15. The initial reference value is at least a luminance to be determined as the paper 103 (drawing area). For example, it is higher than or equal to a predetermined luminance.

The control unit 16 performs Step S12 to Step S14 again, and decides whether or not the count is α (where α is an integer greater than “0”) (Step S19).

If the count is not α (NO in Step S19), then the control unit 16 determines the first area AR1 as the paper 103 candidate when the first average exceeds the second average (YES in Step S20) and the first average exceeds a first average stored in the storage unit 15 (YES in Step S21) (Step S22).

Next, the control unit 16 updates the first average stored in the storage unit 15 (Step S24). The control unit 16 also updates the first area AR1 stored in the storage unit 15 as the paper candidate.

In other words, the control unit 16 performs the following first average determination process on the first area AR1 and the second area AR2 obtained by dividing, in the division process (Step S13), the corrected image based on the first reference point P1 and the second reference point P2 placed in the reference point setting process (Step S12). The first average determination process is a process in which a current first average is decided whether or not to exceed a current second average, and a first average stored in the storage unit 15 is updated with the current first average when (i) the current first average exceeds the current second average and (ii) the current first average exceeds the first average stored in the storage unit 15.

Here, the first average stored in the storage 15 is greater than or equal to a predetermined initial reference value. In other words, a value stored in the storage unit 15 prior to the first average determination process is the “initial reference value” being the first average obtained when the count of the counter 16A is “0”. In the first average determination process, the initial reference value stored in the storage unit 15 is updated with a first average when the first average exceeds the initial reference value. Accordingly, after the first average determination process, the first average stored in the storage unit 15 is greater than or equal to the “initial reference value”.

In contrast, if the count is not a (NO in Step S19), then when the first average is lower than or equal to the second average (NO in Step S20) or when the first average is lower than or equal to a first average stored in the storage unit 15 (NO in Step S21), the first area AR1 is not determined as the paper candidate (Step S23). In other words, the first area AR1 is determined to be a desk surface 104S candidate.

Next, the control unit 16 further increments the count by 1 (Step S25).

The control unit 16 repeats a set of the foregoing steps, i.e. Step S12, S13, S14, S15, S19, S20, S21, S22, S23, S24, and S25, until the count reaches α.

Even when the count has reached α (YES in Step S19), the control unit 16 decides whether or not the first average exceeds the second average (Step S26). If the first average exceeds the second average (YES in Step S26), then the control unit 16 decides whether or not the first average is higher than or equal to a first average stored in the storage unit 15 (Step S27).

If the first average is higher than or equal to the first average stored in the storage unit 15 (YES in Step S27), then the control unit 16 determines, as the paper 103, the first area AR1 of when the count is α (Step S28).

In contrast, if the count is α (YES in Step S19), then when the first average is lower than or equal to the second average (NO in Step S26) or when the first average is lower than the first average stored in the storage unit 15 (NO in Step S27), the control unit 16 determines, as the paper 103, the paper candidate stored in the storage unit 15 (Step S29). Specifically, the control unit 16 causes the drawing area determination unit 17 to determine, as the paper 103 (drawing area), the first area corresponding the first average stored in the storage unit 15. That means the drawing area determination unit 17 determines, as the paper 103 (drawing area), the first area corresponding the first average stored in the storage unit 15. In other words, the first area AR1 of when the count is a is determined to be an area other than the paper 103, i.e. the desk surface 104S.

Like the case of the count of less than α, even when the count is α (YES in Step S19), the first average stored in the storage unit 15 may be updated with a current first average when (i) the current first average exceeds a current second average and (ii) the current first average exceeds the first average stored in the storage unit 15.

In other words, the control unit 16 repeat a first average determination process α times (a predetermined number of times) while changing the first reference point and the second reference point, the first average determination process being a process in which: whether or not a current first average exceeds a current second average is decided; and when the current first average exceeds the current second average and the first average stored in the storage unit 15, the first average stored in the storage unit 15 is updated with the current first average. The drawing area determination unit 17 determines, as the paper 103 (drawing area), the first area corresponding to the first average stored in the storage unit 15 after the first average determination process is repeated α times (the predetermined number of times) by the control unit 16.

Next, the control unit 16 resets the counter 16A (Step S30).

### <Advantages>

As described above, the embodiment takes advantage of the luminance of the paper surface 103S higher than that of the desk surface 104S to identify the paper 103 (drawing area) in the following manner.

When the digital pen 1 faces to the paper surface 103S, i.e. when the pen tip of the digital pen 1 is on the paper 103, the first average in the first area AR1 close to the digital pen 1 exceeds the second average in the second area AR2 away from the digital pen 1. In such a case, the first area AR1 is determined as the paper candidate, and the first average is stored in the storage unit 15.

In contrast, when the digital pen 1 does not face to the paper surface 103S, i.e. when the pen tip of the digital pen 1 is not on the paper 103, the first average does not exceeds the second average. In such a case, the first area AR1 is not determined as the paper candidate, and the first average is not stored in the storage unit 15.

The control unit 16 repeats the first average determination process a predetermined number of times to obtain the highest first average being the highest average luminance, stored in the storage unit 15. Then, the drawing area determination unit 17 determines, as the paper surface 103S, the first area AR1 corresponding the first average stored in the storage unit 15.

In this way, even when an area where the luminance is relatively high but lower than that of the paper 103, such as a non-paper area (for example, the desk 104), is included in the first area AR1, the average luminance of the first area AR1 is lower than that of the first area AR1 including only the paper 103 because the luminance of the non-paper area is lower than that of the paper 103.

As a result, when the area where the luminance is relatively high but lower than that of the paper 103 (drawing area) is included in the first area AR1, it is possible to prevent the area from being incorrectly determined to be a part of the paper 103. Thus, the accuracy of identifying the paper 103 (drawing area) is improved.

Furthermore, in the embodiment, the digital pen 1 further includes the estimation unit 14 for estimating the position of the digital pen 1 based on the paper 103 (drawing area) determined by the drawing area determination unit 17, and the storage unit 15 further stores the positional information indicating the position estimated by the estimation unit 14.

With this, the digital pen 1 estimates its position based on the paper 103 (drawing area), and thus the position of the digital pen 1 can be estimated without requiring a specific pattern for position detection.

Furthermore, in the embodiment, the digital pen 1 further includes the positional information output unit 18 for outputting the positional information to a communication device used in combination with the digital pen.

With this, the digital pen 1 can provide the positional information to the communication device, and thus the communication device can obtain the motion trajectory of the digital pen 1 from the provided positional information. Accordingly, characters or figures drawn on the paper 103 (in the drawing area) with the digital pen 1 can be stored on the communication device in a paperless manner.

### Embodiment 2

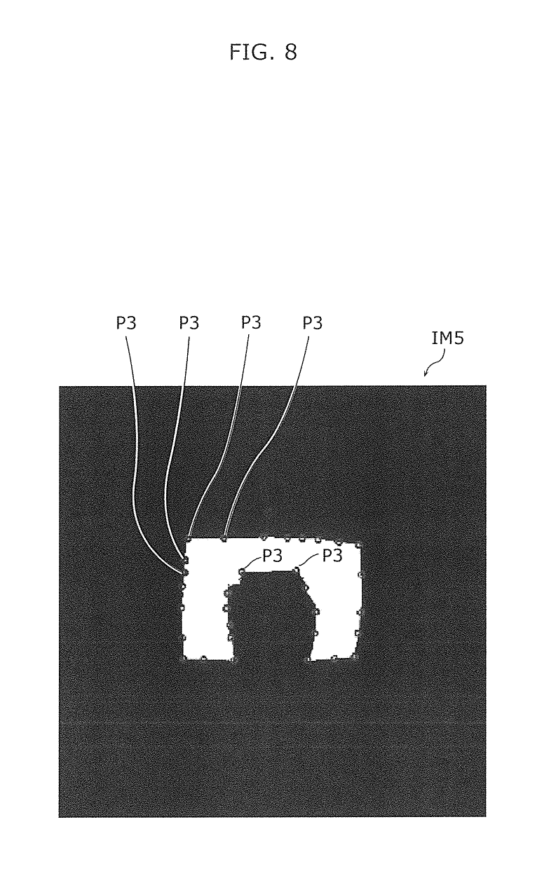

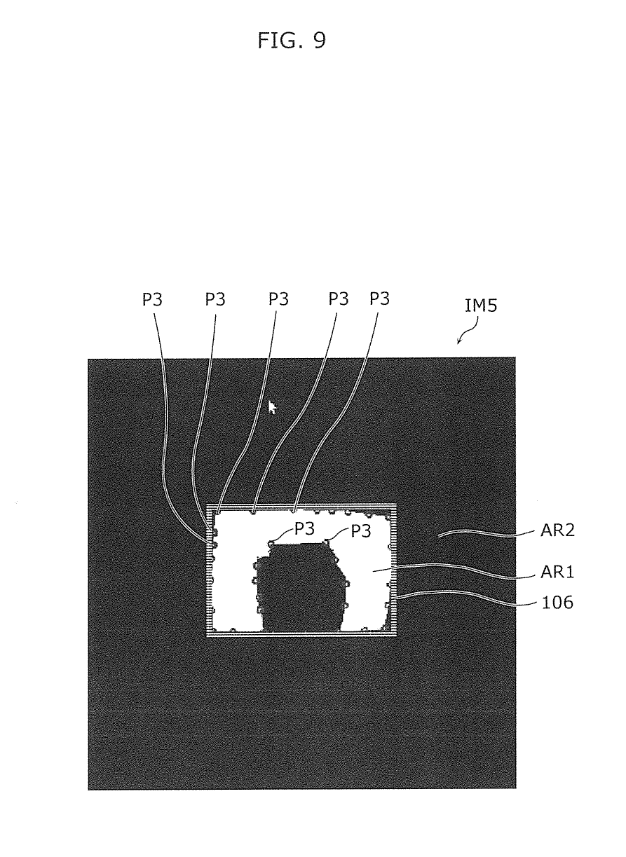

FIG. 8 and FIG. 9 each illustrate a diagram for describing an operation of a digital pen according to one exemplary embodiment 2. It is to be noted that the basic structure of the digital pen according to the embodiment 2 is the same as that of the digital pen according to the embodiment 1, and thus the illustration and the description are omitted.

### <Operation of Digital Pen>

The image correction unit 11 generates a black-and-white image by binarizing the divided image IM3 divided into the first area AR1 determined as the paper 103 by the control unit 16 and the second area AR2 determined as an area other than the paper 103, and rotates the first area AR1 until the long side becomes horizontal.

The control unit 16 places multiple points P3 on the boundary between the first area AR1 converted into white and the second area AR2 converted into black. Then the black-and-white image IM5 shown in FIG. 8 is generated. The black-and-white image IM5 shown in FIG. 8 differs from the divided image IM3 in that the digital pen 1 is substantially located at the center of the paper 103.

As shown in FIG. 9, the drawing area determination unit 17 determines, as the paper 103 (drawing area), a rectangle 106 including all the points P3. Specifically, the drawing area determination unit 17 determines, as the paper 103 (drawing area), the rectangle 106 including all the points P3 on the boundary between the first area AR1 corresponding to the first average stored in the storage unit 15 and the second area AR2 after the first average determination process is repeated the predetermined number of times by the control unit 16. Here, the “rectangle including all the points” means, for example, the rectangle circumscribing the polygon whose vertices are the points.

### <Advantages>

With this, as described above, multiple points P3 are drawn on the boundary between the first area AR1 determined as the paper 103 and the second area AR2, and the rectangle 106 including all the points P3 is obtained as an image of the paper 103 (drawing area). Accordingly, it is possible to obtain information representing the paper 103 through easy software processing.

### Embodiment 3

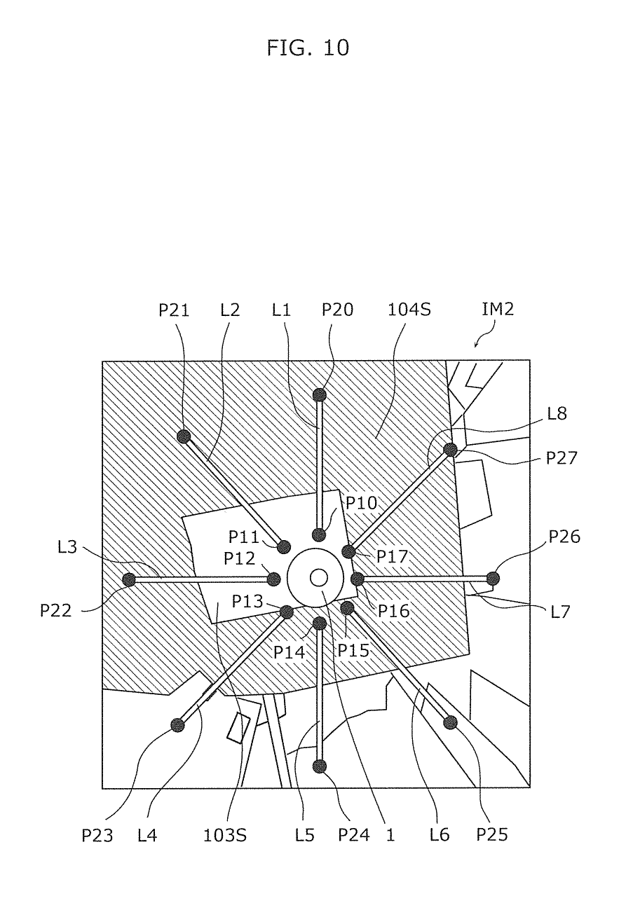

FIG. 10 illustrates a diagram for describing an operation of a digital pen according to one exemplary embodiment 3. It is to be noted that the basic structure of the digital pen according to the embodiment 3 is the same as that of the digital pen according to the embodiment 1, and thus the illustration and the description are omitted.

### <Operation of Digital Pen>

The control unit 16 does not randomly place the first reference point P1 and the second reference point P2 in the corrected image IM2. As shown in FIG. 10, the first reference points P10 to P17 are respectively placed on one ends of line segments L1 to L8 radially arranged around a predetermined position (in this case, the position of the digital pen 1), and the second reference points P20 to P27 are respectively placed on the other ends. Specifically, the first reference points P10 to P17 are each an inner end of one of the line segments L1 to L8 radially arranged around a predetermined point in the image, and the second reference points P20 to P27 are each an outer end of the line segment.

### <Advantages>

With this, a set of the first reference points P10 to P17 and a set of the second reference points P20 to P27 each can be circularly arranged around the position of the digital pen 1. Accordingly, compared with a random setting of the first reference point P1 and the second reference point P2 in the corrected image IM2, the even arrangement of the first reference points P10 to P17 and the second reference points P20 to P27 can be achieved in a wide range. As a result, it is possible to more accurately determine the first area AR1 as the paper 103.

### Embodiment 4

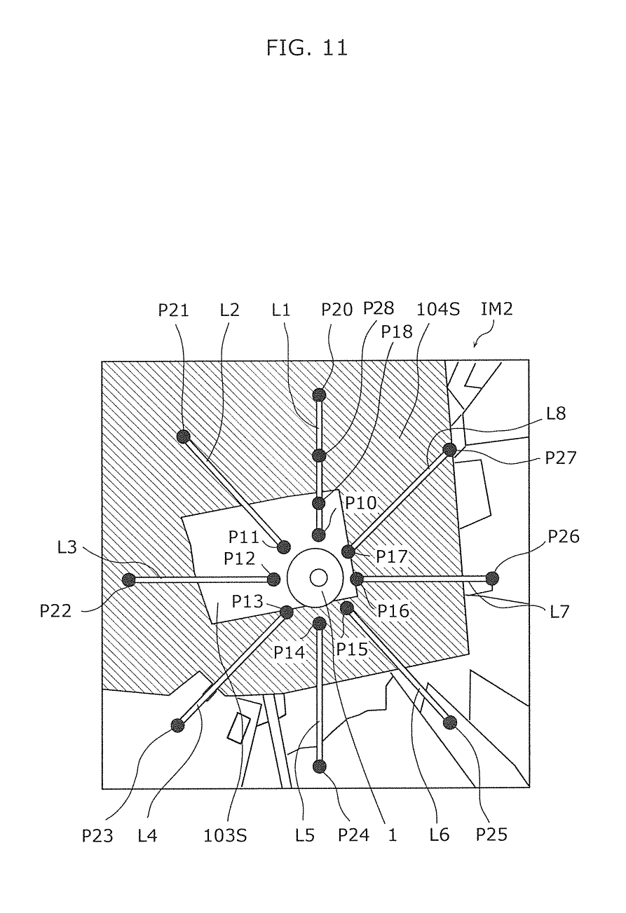

FIG. 11 illustrates a diagram for describing an operation of a digital pen according to one exemplary embodiment 4. It is to be noted that the basic structure of the digital pen according to the embodiment 4 is the same as that of the digital pen according to the embodiment 1, and thus the illustration and the description are omitted.

### <Operation of Digital Pen>

The control unit 16 places the first reference point P18 and the second reference point P28 not only on the ends of each of the line segments L1 to L8 (in this case, the line segment L1), but also along each line segment.

### <Advantages>

With this, the first reference point P18 and the second reference point P28 are also placed on each of the radially-arranged line segments L1 to L8 (in this case, the line segment L1), and thus more first reference points P18 and more second reference points P28 can be reserved as the number of line segments increase.

Accordingly, more possible first areas AR1 to be determined as the paper 103 and more possible second areas AR2 to be determined as the area other than the paper 103 can be used to decide whether or not each of the possible first areas AR1 is the paper, and thus the accuracy of identifying the paper is further improved.

The herein disclosed subject matter is to be considered descriptive and illustrative only, and the appended Claims are of a scope intended to cover and encompass not only the particular embodiments disclosed, but also equivalent structures, method, and/or uses.

For example, in the foregoing description, the digital pen has been for making a drawing on a paper, but a target on which a drawing is made with the digital pen is not limited to the paper. A planar drawing area such as a white board is possible.

Furthermore, in the foregoing description, the image obtainment unit has included a mirror such as the hemisphere mirror 102 and the camera module 10 for capturing a mirror image on the mirror, but need not include the mirror. In other words, the image obtainment unit may include a camera module provided with an image-capturing surface facing to the paper, and obtain an image captured by such a camera module.

Furthermore, in the foregoing description, the digital pen has included the image correction unit 11, but it is optional. In other words, the area division unit may divide not the corrected image but an image captured by the camera module into the first area and the second area.

Furthermore, in the foregoing description, the digital pen has included the positional information output unit 18, but it is optional. In other wards, the positional information stored in the storage unit 15 may be provided to an external memory (for example, a USB memory) connected to the digital pen.

Furthermore, in the foregoing description, the digital pen has included the estimation unit 14, but it is optional. In other words, the digital pen may only identify the paper, and need not estimate the position of the digital pen.

For example, a part of structural elements included in the foregoing digital pen may be implemented, specifically, as a microprocessor, a ROM, a RAM, and so on. A computer program is stored in the RAM or a hard disk drive. Each of the structural elements achieves its function through the microprocessor's operation according to the computer program. Here, the computer program is configured by combining plural instruction codes indicating instructions for the computer in order to achieve predetermined functions.

Furthermore, a part of the structural elements included in the foregoing digital pen may be configured from a single System-LSI (Large-Scale Integration). The System-LSI is a super-multi-function LSI manufactured by integrating constituent units on one chip, and is specifically a computer system configured by including a microprocessor, a ROM, a RAM, and so on. A computer program is stored in the RAM. The System-LSI achieves its function through the microprocessor's operation according to the computer program.

Furthermore, a part of the structural elements included in the foregoing digital pen may be configured as an IC card which can be attached and detached from the respective apparatuses or as a stand-alone module. The IC card or the module is a computer system configured from a microprocessor, a ROM, a RAM, and so on. The IC card or the module may also include the aforementioned super-multi-function LSI. The IC card or the module achieves its function through the microprocessor's operation according to the computer program. The IC card or the module may also be implemented to be tamper-resistant.

### INDUSTRIAL APPLICABILITY

One or more exemplary embodiments disclosed herein are applicable to input devices of user controlled apparatuses such as a STB (Set Top Box), a gaming system, and an audio visual apparatus.

1. A digital pen for making a drawing in a drawing area having a planar configuration, the digital pen comprising:
an image obtainment unit configured to obtain an image of an area including the digital pen and the drawing area;
an area division unit configured to divide the image obtained by the image obtainment unit into: a first area that is displayed in a color of a first reference point and a color close to the color of the first reference point; and a second area that is displayed in a color of a second reference point and a color close to the color of the second reference point, the second reference point being farther away from the digital pen than the first reference point;
an average calculation unit configured to calculate a first average and a second average, the first average being an average luminance in the first area, the second average being an average luminance in the second area;
a storage unit for storing the first average;
a control unit configured to repeat a first average determination process a predetermined number of times while changing the first reference point and the second reference point, the first average determination process being a process in which: whether or not a current first average exceeds a current second average is decided; and when the current first average exceeds the current second average and the first average stored in the storage unit, the first average stored in the storage unit is updated with the current first average; and
a drawing area determination unit configured to determine, as the drawing area, the first area corresponding to the first average stored in the storage unit after the first average determination process is repeated the predetermined number of times by the control unit.

2. The digital pen according to claim 1,
wherein the first average stored in the storage is greater than or equal to a predetermined initial reference value.

3. The digital pen according to claim 1,
wherein the first reference point is an inner end of a line segment, and the second reference point is an outer end of the line segment, the line segment being one of a plurality of line segments radially arranged around a predetermined point in the image.

4. The digital pen according to claim 3,
wherein the first reference point and the second reference point are each a predetermined point on the line segment.

5. The digital pen according to claim 1,
wherein the drawing area determination unit is configured to determine, as the drawing area, a rectangle including all points on a boundary between the first area corresponding to the first average stored in the storage unit and the second area after the first average determination process is repeated the predetermined number of times.

6. The digital pen according to claim 1, further comprising
an estimation unit configured to estimate a position of the digital pen based on the drawing area determined by the drawing area determination unit,
wherein the storage unit further stores positional information indicating the position estimated by the estimation unit.

7. The digital pen according to claim 6, further comprising
a positional information output unit configured to output the positional information to a communication device used in combination with the digital pen.
